(19) United States
(12) Patent Application Publication
(10) Pub. No.: US 2008/0162292 A1
(43) Pub. Date: Jul. 3, 2008

(54) POINT-OF-SALES SYSTEM

(76) Inventor: Rahi Roshandel, San Diego, CA (US)

Correspondence Address: HOLLAND & KNIGHT LLP, 10 ST. JAMES AVENUE, 11th Floor, BOSTON, MA, 02116-3889, US

(21) Appl. No.: 11/618,990

(22) Filed: Jan. 2, 2007

(51) Int. Cl. G06Q 20/00

(52) U.S. Cl. 705/16

(57) ABSTRACT

Methods and apparatus, including computer program products, for a point-of-sales (POS) system. A method includes, in a POS device linked to a Voice over Internet Protocol (VoIP) network, enabling a set of VoIP core functions interfaced with a POS application process, the set of VoIP core functions selected from the group consisting of receiving a VoIP call, initiating a VoIP call, transferring a VoIP call, sending telephony data and receiving telephony data.

### BACKGROUND

The present invention relates to data processing by digital computer, and more particularly to a point-of-sales (POS) system.

The term POS is often used in connection with hardware and software for checkouts, and in the case of variable locations, with wireless systems. POS systems evolved from the mechanical cash registers of the first half of the 20th century. During the late 1980s and throughout the 90s stand-alone credit card devices were developed so credit card processing could be more easily and securely added. These relatively simple devices have evolved in recent years to allow multiple applications (e.g., credit card, gift card, age verification, employee time clock, and so forth) to reside on one device. Some wireless POS systems for restaurants not only allow for mobile payment processing, they also allow servers to process the entire food order right at tableside.

Most retail POS systems may do more than just “point of sale” tasks. Many POS systems include fully integrated accounting, inventory management, open to buy forecasting, customer relation management (CRM), service management, rental, and payroll modules.

POS technology users are looking at new ways to reduce operational cost in their store environment. As the investment for hardware deployment of any sort is questioned by senior management, multifunctional capabilities provide a way of overcoming such justifications. For example, separate telephones and POS devices require two sets of support contracts or skill sets, and can take up additional room at a check-out lane.

### SUMMARY

The present invention provides methods and apparatus, including computer program products, for a point-of-sales (POS) system.

In general, in one aspect, the invention features a Point-of-Sales (POS) system including a central processing unit (CPU), a memory including a POS application process and a Voice over Internet Protocol (VoIP) driver process, an input/output device, a telephony device linked to the VoIP driver process, and a communications link connecting the VoIP driver process to a VoIP network.

In embodiments, the telephony device can be a VoIP phone. The POS application process can include a process that enables notification of an incoming call from the VoIP network. The POS application process can include a process that initiates a call to any location on the VoIP network. The POS application process can include a process that initiates a call to any location on a telephone network.

The POS application process can include a process that transfers an incoming call to another location on the VoIP network according to business rules. The POS application process can include a process that can receive and transmit telephony data. The telephony data can include Extensible Markup Language (XML) representations of actions taken by a user. The telephony data can include a text message.

The VoIP driver process can expose core functionality of the VoIP network to the POS application process for receiving a call, initiating a call, transferring a call, sending telephony data and receiving telephony data.

In another aspect, the invention features a method including, in a point-of-sales (POS) device linked to a Voice over Internet Protocol (VoIP) network, enabling a set of VoIP core functions interfaced with a POS application process, the set of VoIP core functions selected from the group consisting of receiving a VoIP call, initiating a VoIP call, transferring a VoIP call, sending telephony data and receiving telephony data.

In embodiments, receiving a VoIP call can include receiving notification of the VoIP call, answering the VoIP call in conjunction with business rules based on caller identification or data attachment received from the VoIP network, and cancelling the VoIP call in conjunction with business rules based on caller identification or data attachment received from the VoIP network.

Transferring a VoIP call can include transferring an incoming call to another location on the VoIP network based on invoked business rules.

The telephony data can include an Extensible Markup Language (XML) representation of actions taken by a user or the POS device. The telephony data can include a text message.

The invention can be implemented to realize one or more of the following advantages.

The system combines Voice over Internet Protocol (VoIP) in conjunction with a POS application that benefits customer service, functionality and maintenance costs. Users realize accurate call routing, automated order placement, automated inquiry, order status and so forth.

The system eliminates a need to support separate systems and takes up less physical space. The system enables elimination of existing phone equipment, resulting in a reduction of a number of hardware components within a retail store environment, reduction of a number of failure points, reduction in a number of service calls, and reduction in associated maintenance cost.

The system benefits customers with improved customer service, accurate call routing, automated order placement, automated inquiry, order status and so forth.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary point-of-sales system.

FIG. 2 is a flow diagram.

Like reference numbers and designations in the various drawings indicate like elements.

### DETAILED DESCRIPTION

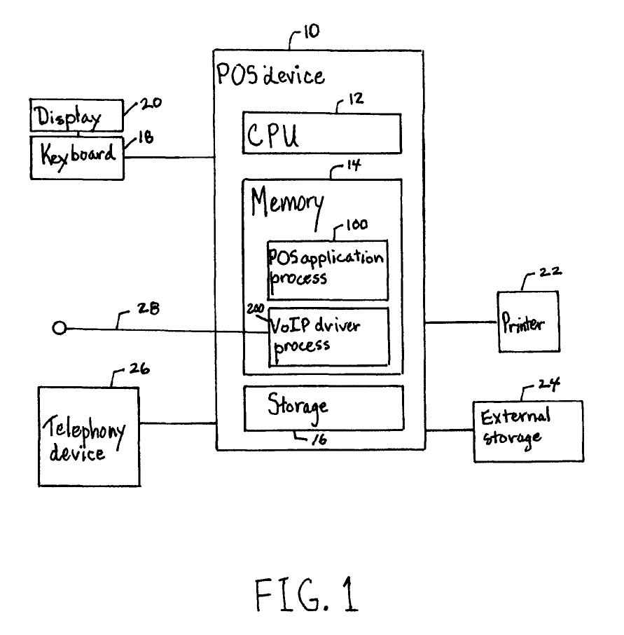

As shown in FIG. 1, an exemplary point-of-sales (POS) system 10 includes a central processing unit (CPU) 12, a memory 14, and a storage 16. The CPU 12 performs predetermined processing based on a program(s) stored in the memory 14 and/or the storage 16 and using the memory 14 as a work area. The POS system 10 can be linked to a keyboard 18 and a display 20. A user thus can operate the POS system 10 through the keyboard 18 to perform, for example, settlement processing. In other examples, the user can operate the POS system 10 using a touch screen or other suitable input device.

In one example, a printer 22 and an external storage unit 24 are connected to the POS system 10.

The printer 22 can print commodity information of a commodity to issue a receipt to be handed to a customer and the external storage unit 24 can store commodity information. In examples, the external storage unit 24 can refer to back office systems, corporate computer systems and/or networks, and so forth.

In still other examples, the POS system 10 can include a transaction handling device or devices, such as a cash drawer, credit card processing unit, cash dispensing unit and so forth.

The POS system 10 includes a telephony device 26, such as a wired or wireless receiver and microphone. An example of a telephone device 26 is a VoIP phone. A VoIP phone is a telephone set designed specifically for use in the VoIP network 26 by converting standard telephone audio into a digital format that can be transmitted over the Internet, and by converting incoming digital phone signals from the Internet to standard telephone audio. A VoIP phone enables the user to take advantage of VoIP technology without involving a personal computer, although an Internet connection is required.

VoIP is an IP telephony term for a set of facilities used to manage the delivery of voice information over the Internet. VoIP involves sending voice information in digital form in discrete packets rather than by using the traditional circuit-committed protocols of the public switched telephone network (PSTN).

VoIP derives from the VoIP Forum, an effort by major equipment providers to promote the use of ITU-T H.323, a standard for sending voice (audio) and video using Internet Protocol (IP) on the public Internet and within an intranet. The VoIP Forum also promotes use of directory service standards so that users can locate other users and the use of touch-tone signals for automatic call distribution and voice mail. In addition to Internet IP, VoIP uses the real-time protocol (RTP) to help ensure that packets are delivered in a timely fashion.

Using VoIP, an enterprise can position a VoIP device at a gateway. The gateway receives packetized voice transmissions from users within the enterprise and then routes them to other parts of its intranet (local area or wide area network) or, using a T-carrier system or E-carrier interface, sends them over the PSTN.

Memory 14 includes a point-of-sales (POS) application process 100 and a Voice over Internet Protocol (VoIP) driver process 200.

In one example, the POS system 10 is implemented as a WinTel-based POS terminal device and the VoIP driver process 200 as H.323-based client software integrated with the POS application process 100.

As described above, the POS system 10 is a computing device with a human interface mechanism such as a keyboard, numeric keypad, touch screen, voice recognition, or other mechanism or process designed for servicing specific categories of a business process. Example POS systems include a kiosk device that consumers use at a retail store, bank, or airport. Other POS system examples include the retail POS system that is operated by retail store personnel to execute accurate pricing, tax calculations, and transaction documentation (receipts) for a consumer. A banking POS system operated by banking personnel is typically utilized to process deposits and withdrawals and many other types of secure transactions.

The POS system 10 differs from standard computing workstation devices in that it includes a mixture of configured applications. In retail and banking for example, the main POS application is typically a very complex set of software modules designed to securely and accurately transact business processes for a specific business domain. The POS system 10 can utilize standard computing hardware or embedded hardware depending on the requirements; the mixture of software is varied depending on the application requirements. The most ubiquitous types of POS systems are retail, banking, self-checkout, mobile PDA-like devices, and kiosk devices.

The POS system 10 can include a set of business specific devices. For example, in a retail environment there are special devices for scanning barcodes, reading magnetic stripes on credit and debit cards, receipt printers, scales, numeric customer displays, cash drawers (tills), and so forth.

Integration of the telephony device 26 into the POS application process 100 through the VoIP driver process 200 on the VoIP network 28 enables user access to a complete phone system while eliminating traditional phone connectivity.

Pop-up messaging on the display 20 enables the user to decide on either responding to a call received or being able to transfer the call with the appropriate buttons displayed on the display 20 using, for example, touch screen technology. This can occur during idle tune or while a transaction at the POS system 10 is in progress. The user can also make calls for any reason, such as for help, information query, or directly to customers. The POS system 10 includes different options for such connectivity. One option enables the user to use a wired handset device with receiver and microphone to enable traditional use with Universal Serial Bus (USB) interface connectivity. Another option is the wired headset and microphone connected to a USB port. Still another option is a wireless headset and microphone using a Bluetooth interface using a direct connection or USB-interfaced Bluetooth radio.

As described above, a telephone call can be received using the POS system 10. The VoIP driver process 200 enables the POS application process 100 to receive notification of an incoming call from the VoIP network 28. The POS application process 100 can answer or cancel the incoming call. The POS application process 100 can invoke selected business rules based on caller identification or data attachments received from the VoIP network 28. For example, the POS application process 100 can deny calls from some sources and accept calls from some sources. Based upon the caller identification or attached telephony data, the POS application process 100 can interrupt a current transaction for a high priority call or deny call reception from a source that is deemed low priority.

The POS application process 100 can initiate a call using the VoIP driver process 200 to any location on the VoIP network 28 that is configured to receive calls from that POS system 10. A call in progress can be terminated at any time by the POS application process 100 through user interaction or invoked business rules, such as a call time limit or actions taken based on attached telephony data.

The POS application process 100 can transfer an incoming call through the VoIP driver process 200 to another location in the VoIP network 28 based upon invoked business rules. Typically, the POS application process 100 alerts the user that an incoming call event has occurred. In certain cases, such as when the POS application process 100 is at a time-critical juncture in transaction processing, the POS application process 100 may prohibit answering the call and transfer the call to another location in the VoIP network 28.

The POS application process 100 can receive and transmit telephony data using the VoIP driver process 200. This telephony data is typically an Extensible Markup Language (XML) representation of actions taken by the caller or POS system 10. For example, the POS application process 100 may, at some point in a transaction, require data from a store manager to authorize a transaction limit override. The POS application process 100 can automatically call the manager's IP phone through the VoIP network 28 and, using telephony functionality, request a response that is either keyed at the manager's phone or spoken. If spoken, voice recognition can be used to produce telephony data. This telephony data, whether keyed or produced from voice recognition, is sent back to the POS application process 100 for processing, resulting in an override being approved or denied.

The VoIP driver process 200 exposes core functionality of the VoIP network 28 to the POS application process 100 for receiving, initiating, transferring a call, and sending/receiving telephony data. The VoIP driver process 200 is utilized through method invocation. Notifications of incoming calls and VoIP state are transmitted to the POS application process 100 through a callback interface. This callback mechanism is operating-system transparent, but on Microsoft Windows® platforms is abstracted to Win32 callbacks, component object model (COM) connection points, Java® events, or .Net events.

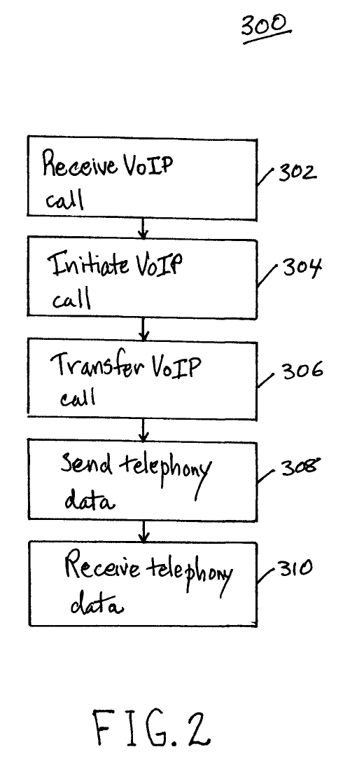

As shown in FIG. 2, a process 300 includes, in a point-of-sales (POS) device linked to a Voice over Internet Protocol (VoIP) network, receiving (302) a VoIP call, initiating (304) a VoIP call, transferring (306) a VoIP call, sending (308) telephony data and receiving (310) telephony data. The telephony data can include an Extensible Markup Language (XML) representation of actions taken by a user or the POS device 10.

Receiving (302) a VoIP call can include receiving notification of the VoIP call, answering the VoIP call in conjunction with business rules based on caller identification or data attachment received from the VoIP network, and cancelling the VoIP call in conjunction with business rules based on caller identification or data attachment received from the VoIP network.

Transferring (306) a VoIP call can include transferring an incoming call to another location on the VoIP network based on invoked business rules.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A Point-of-Sales (POS) system comprising:
a central processing unit (CPU);
a memory including a POS application process and a Voice over Internet Protocol (VoIP) driver process;
an input/output device;
a telephony device linked to the VoIP driver process; and
a communications link connecting the VoIP driver process to a VoIP network.

2. The POS system of claim 1 wherein the telephony device is a VoIP phone.

3. The POS system of claim 1 wherein the POS application process comprises a process that enables notification of an incoming call from the VoIP network.

4. The POS system of claim 1 wherein the POS application process comprises a process that initiates a call to any location on the VoIP network.

5. The POS system of claim 1 wherein the POS application process comprises a process that initiates a call to any location on a telephone network.

6. The POS system of claim 1 wherein the POS application process comprises a process that transfers an incoming call to another location on the VoIP network according to business rules.

7. The POS system of claim 1 wherein the POS application process comprises a process that can receive and transmit telephony data.

8. The POS system of claim 7 wherein the telephony data comprises Extensible Markup Language (XML) representations of actions taken by a user.

9. The POS system of claim 7 wherein the telephony data comprises a text message.

10. The POS system of claim 1 wherein the VoIP driver process exposes core functionality of the VoIP network to the POS application process for receiving a call, initiating a call, transferring a call, sending telephony data and receiving telephony data.

11. A computer-implemented method comprising:
in a point-of-sales (POS) device linked to a Voice over Internet Protocol (VoIP) network, enabling a set of VoIP core functions interfaced with a POS application process, the set of VoIP core functions selected from the group consisting of receiving a VoIP call, initiating a VoIP call, transferring a VoIP call, sending telephony data and receiving telephony data.

12. The computer-implemented method of claim 11 wherein receiving a VoIP call comprises:
receiving notification of the VoIP call;
answering the VoIP call in conjunction with business rules based on caller identification or data attachment received from the VoIP network; and
cancelling the VoIP call in conjunction with business rules based on caller identification or data attachment received from the VoIP network.

13. The computer-implemented method of claim 11 wherein transferring a VoIP call comprises transferring an incoming call to another location on the VoIP network based on invoked business rules.

14. The computer-implemented method of claim 11 wherein the telephony data comprises an Extensible Markup Language (XML) representation of actions taken by a user or the POS device.

15. The computer-implemented method of claim 11 wherein the telephony data comprises a text message.

16. A computer program product, tangibly embodied in an information carrier, for processing in a Point-of-Sale (POS) device linked to a Voice over Internet Protocol network, the computer program product being operable to cause data processing apparatus to:
enable a set of VoIP core functions interfaced with a POS application process, the set of VoIP core functions selected from the group consisting of receiving a VoIP call, initiating a VoIP call, transferring a VoIP call, sending telephony data and receiving telephony data.

17. The computer program product of claim 16 wherein receiving a VoIP call comprises:
receiving notification of the VoIP call;
answering the VoIP call in conjunction with business rules based on caller identification or data attachment received from the VoIP network; and
cancelling the VoIP call in conjunction with business rules based on caller identification or data attachment received from the VoIP network.

18. The computer program product of claim 16 wherein transferring a VoIP call comprises transferring an incoming call to another location on the VoIP network based on invoked business rules.

19. The computer program product of claim 16 wherein the telephony data comprises an Extensible Markup Language (XML) representation of actions taken by a user or the POS device.

20. The computer program product of claim 16 wherein the telephony data comprises a text message.
